(19) United States
(12) Patent Application Publication
(10) Pub. No.: US 2013/0304631 A1
(43) Pub. Date: Nov. 14, 2013

(54) WI-FI HOT-SPOT NETWORKING ECOMMERCE

(71) Applicant: Jinhui WANG, Montreal (CA)

(72) Inventor: Jinhui WANG, Montreal (CA)

(73) Assignee: TELEFONAKTIEBOLAGET LM ERICSSON (PUBL), Stockholm (SE)

(21) Appl. No.: 13/468,340

(22) Filed: May 10, 2012

(51) Int. Cl. G06Q 20/22; G06F 15/173

(52) U.S. Cl. 705/39; 709/225

(57) ABSTRACT

Methods and systems for using a device as a wireless hotspot service provider are disclosed. An exemplary method for providing a hotspot service provider includes performing a first registration of a first device as a first hotspot service provider in a first coverage are of the first device. The first registration includes identifying an account of an owner of the first device. A second registration of a second device as a hotspot service consumer is also performed. The second registration includes identifying an account of an owner of the second device. A first amount is charged against an account of the owner of the second device based on a resource usage by the second device via the first device. At least a portion of the first amount is credited to the account of the owner of the first device.

### TECHNICAL FIELD

A method and system relating to hotspots in a communication network and in particular to a method and system in which a subscriber's user equipment is used to provide a communication network hotspot to other users.

### BACKGROUND

Geographical coverage of communication networks is increasing rapidly. For example, many airports provide wireless connection to the Internet via one or more gateway devices. An area where wireless connection to the Internet or to another network is provided is sometimes called a wireless hotspot. Wireless hotspots typically support the IEEE 802.11 family of wireless communication standards. Typically, a provider of a wireless hotspot may charge a fee for access. These fees may be relatively expensive. Further, many areas have no wireless hotspot coverage at all, even though these areas may provide access to a wireless telecommunications network such as via a cellular, e.g., long term evolution (“LTE”), communication network. Also, where wired access to the network is provided, a user may not be able to connect directly to the wired network.

Although many public areas are without wireless access to the Internet, there may be many subscribers to wired or wireless access to the Internet in any given area. Many of these subscribers have unused resources that they pay for. For example, a subscriber may pay for Internet access through their wireless communication carrier or cable modem service provider that is limited to a download volume per month that they routinely do not exceed, e.g., 3 GBytes. For example, the subscriber may only actually use 500 Mbytes per month. Such excess resources currently are wasted.

It is desirable to have a way to make use of the excess and unused bandwidth in a manner that can provide additional access to the communication network for other users.

### SUMMARY

Methods and systems for using a subscriber device as a hotspot service provider are disclosed. According to one aspect, a method for using a first device as a hotspot service provider includes performing a first registration of the first device as a first hotspot service provider. The first registration includes identifying an account of an owner of the first device. A second registration of a second device, in a coverage area of the first device, as a hotspot service consumer is also performed. The second registration includes identifying an account of an owner of the second device. A first amount is charged against an account of the owner of the second device based on a resource usage by the second device via the first device. At least a portion of the first amount is credited to the account of the owner of the first device.

According to another aspect, a hotspot management computing device is provided. The device includes a memory and a processor. The memory is configured to store first account information concerning a first subscriber and second account information of a second subscriber, where the first subscriber is associated with a first device capable of functioning as a hotspot service provider and the second subscriber is associated with a second device capable of functioning as a hotspot service consumer. The processor is configured to perform registration of the first and second subscriber. The processor also charges a first amount from the second account of the second subscriber. The amount is based on resource usage of a first set of resources by the second subscriber. The processor also credits at least a portion of the amount to a first account of the first subscriber.

According to another aspect, a first device configurable to provide a hotspot service is provided. The first device includes a memory configured to record an amount of resources allocable to a second device. A processor of the first device is configured to authorize the second device to receive access to a first server via the first device, the authorizing based on information received from a managing computing device.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of an exemplary communication system constructed in accordance with principles of the present invention;

FIG. 2 is a block diagram of an exemplary hotspot manager for management of hotspots constructed in accordance with the present invention;

FIG. 3 is a flowchart of an exemplary process for using a device as a wireless hotspot service provider in accordance with principles of the present invention;

FIG. 4 is a flowchart of an exemplary process for transferring hotspot functionality from a first subscriber in a first coverage area to a third subscriber in a second coverage area;

FIG. 5 is a flowchart of an exemplary process for transferring hotspot functionality from a first subscriber in a first coverage area to a fourth subscriber in the first coverage area; and

FIG. 6 is a flowchart of an exemplary process for providing advertising from a hotspot manager to a subscriber.

### DETAILED DESCRIPTION

Before describing in detail exemplary embodiments that are in accordance with the present invention, it is noted that the embodiments reside primarily in combinations of apparatus components and processing steps related to the provision of hotspots in a communication network. Accordingly, the system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements

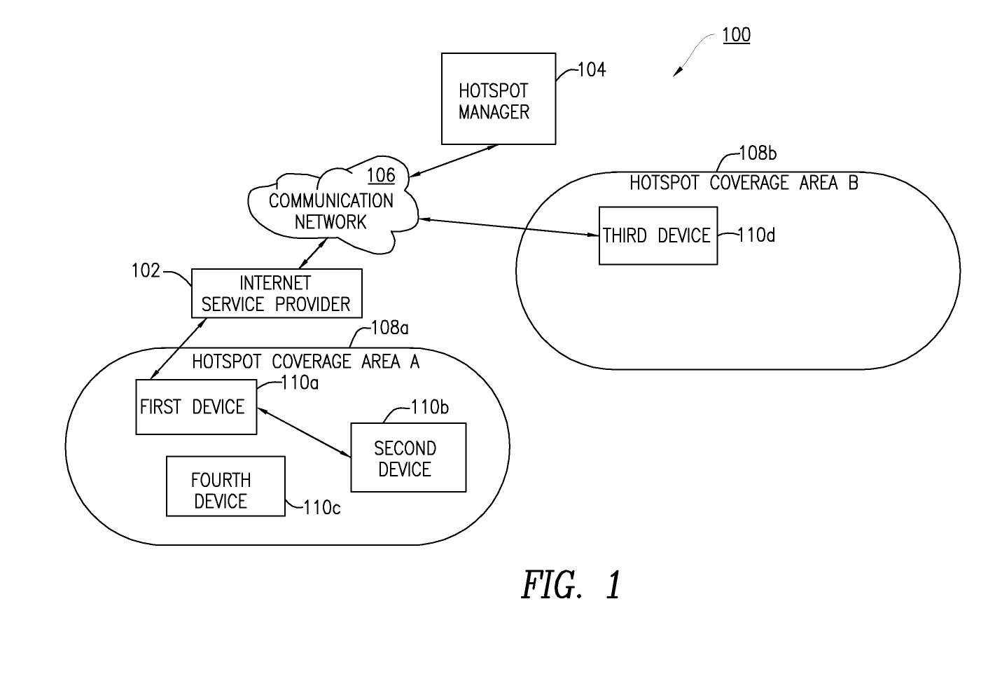

Referring now to the drawing figures, in which like reference designators denote like elements, there is shown in FIG. 1 an exemplary communication system 100 having an Internet service provider 102, a hotspot manager 104, a communication network 106, a first hotspot coverage area 108a and a second hotspot coverage area 108b. The hotspot coverage areas are referred to herein collectively as coverage areas 108. In each coverage area 108, there may be a plurality of devices such as a first device 110a, a second device 110b and a fourth device 110c in the coverage area 108a and a third device 110d in the coverage 108b, referred to collectively herein as devices 110.

Devices 110 may be in communication with the communication network 106 via a wired or wireless connection. For example, a device 110 may be a desktop personal computer that is connected to the communication network 106 via a wired Ethernet connection, but may also include a wireless network device, e.g., personal computer wireless card, that can wirelessly communicate with other devices 110 that are within the wireless coverage area of the desktop PC. One, some or all of the devices 110 may be mobile wireless devices, e.g., wireless routers, tablets, cell phones, laptop computers, and the like. The coverage area may be defined as the range of an antenna of a wireless device designated to be a wireless hotspot service provider.

The Internet service provider 102 provides Internet Access to a device 110 via the communication network 106. In particular, the Internet service provider 102 provides Internet access to the second device 110b via the first device 110a. The hotspot manager 104 manages the use of devices 110 as hotspot service providers and as hotspot service consumers. Although the invention is discussed herein in the context of providing access to the Internet, access to other networks, such as a local area network or a wide area network, is contemplated. Note that the Internet service provider 102 may provide Internet service or connection to any other local or wide area network.

In the configuration of FIG. 1, the second device 110b has access to the Internet via the first device 110a. This access may be obtained by a user of the second device 110b by interacting with a browser web page downloaded from the hotspot manager 104 via the first device 110a, or by interacting with an application interface whose contents are downloaded from the hotspot manager 104. The webpage or application interface may gather certain information from the user of the second device 110b such as a user name and a password. This information, along with a subscriber identity number, may be passed onto the hotspot manager 104 via the first device 110a.

The hotspot manager 104 may register the devices 110 as one of a hotspot service provider and a hotspot service consumer. In the example of FIG. 1, the first device 110a is registered as a hotspot service provider and the second device 110b is registered as a hotspot service consumer. Registration includes identifying an account of an owner of each device. The identification of an account may include creation of a new account or identification of a preexisting account.

The access obtained by the device 110b via the device 110a consumes resources of the device 110a. Thus, the hotspot manager 104 may initially allocate a given amount of resources of the device 110a to provision of Internet access to other devices in coverage area 108a. This allocation may change during the provision of Internet access, depending on, for example, a number of devices seeking Internet access in the coverage area 108a. The allocation of resources may be specified as channels, bandwidth, data volume, access time, etc.

The hotspot manager 104 may monitor the use of resources of the first device 110a by the second device 110b and charge an account of the owner of the second device 110b based on an amount of used resources. The amount charged may be a flat fee for a given amount of resources, a fee based on an amount of data transferred to the second device 110b via the first device 110a, a fee based on an amount of time of access to the provided service, or other fee arrangement. Further, the amount charged may be deducted from the account of the second device owner. The particular fee arrangement may be based on a subscriber agreement between the first device owner and the Internet service provider 102, between the first device owner and the hotspot manager, between the second device owner and the Internet service provider, or between the second device owner and the hotspot manager 104. The fee may be based on an amount of advertisements provided by the hotspot manager. For example, a first fee may be charged to receive no advertisements and a second fee may be charged to receive access with advertisements.

The hotspot manager 104 may credit an account of the first device owner at least a portion of the amount charged to the account of the second device owner. The percent of the amount charged to the account of the second device owner that is credited to the account of the first device owner may be pre-determined according to an agreement between the first device owner and one of the Internet service provider 102 and the hotspot manager 104. In some alternative embodiments, the amount charged and/or the amount credited may be according to the terms of an agreement between the Internet service provider 102 and the hotspot manager 104.

When the second device 110b moves out of the coverage area 108a and into the coverage area 108b, the hotspot manager 104 may detect this change and begin a session of Internet access provided to the second device 110b via the third device 110d acting as a hotspot service provider of the coverage area 108b. Thus, the hotspot manager 104 may have registered the third device 110d, including identifying an account of the owner of the third device 110d. When the second device 110b moves from the first coverage area 108a to the second coverage area 108b, the hotspot manager 104 ceases crediting the account of the first device owner and commences crediting the account of the third device owner.

If, while the second device 110b is receiving access in the first coverage area 108a via the first device 110a, and the first device 110a leaves the first coverage area 108a, the hotspot manager detects this change and begins a session of Internet access provided to the second device 110b via the fourth device 110c acting as a second hotspot service provider in the first coverage area 108a. When the first device 110a moves away from the second device 110b such that the second device 110b is no longer in the first coverage area 108a, the hotspot manager 104 ceases crediting the account of the first device owner and commences crediting the account of the fourth device owner whose device coverage area partially or substantially overlaps the first coverage area and encompasses the second device 110b.

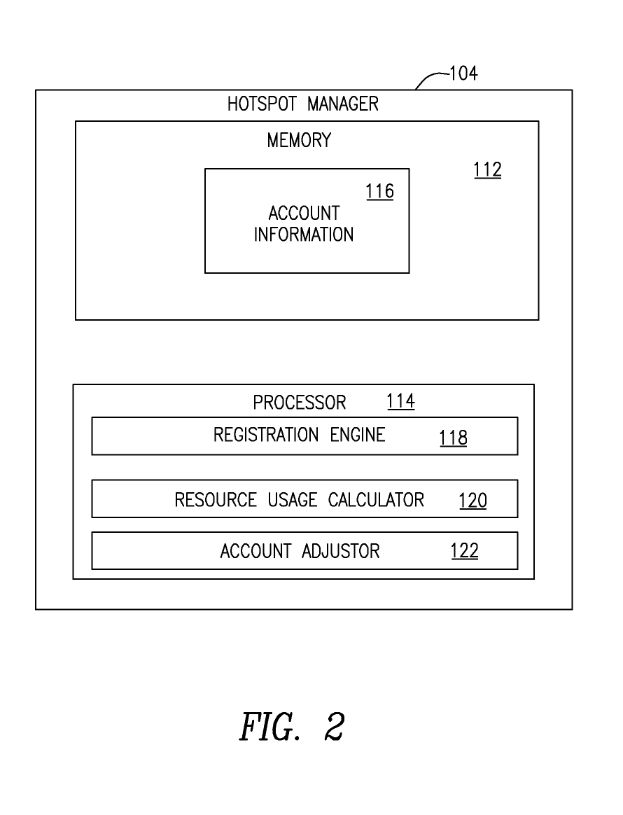

FIG. 2 is a block diagram of an exemplary hotspot manager 104 for management of hotspots constructed in accordance with the present invention. The hotspot manager 104 has a memory 112 and a processor 114. The memory 112 includes account information 116. The account information 116 may include account information of at least one device that may function as a hotspot service provider and at least one device that may function as a hotspot service consumer. The account information may include an identity of a subscriber, a current amount in the subscriber's account, and an amount of resources allocable from the subscriber. The account information may also include information concerning the terms of an agreement between a subscriber and the hotspot manager 104, or between a subscriber and the Internet service provider 102. The hotspot manager 104 may also include components such as a display unit, input devices, and the like. It is contemplated that the memory may include non-volatile memory such as a hard drive, flash memory, etc. in addition to volatile memory.

The processor 114 is programmed or configured to perform the functions of a registration engine 118, a resource usage calculator 120, and an account adjustor 122. The registration engine 118 performs a registration process to register a device as a hotspot service provider or as a hotspot service consumer. The registration engine 118 may further select which one or more of a plurality of devices 110 is to serve as a hotspot service provider. The registration engine 118 may further determine an amount of resources of a device assigned to act as a hotspot service provider to be allocated to hotspot service consumers. This determination may be made based on negotiation between the registration engine 118 and a device 110a chosen as the hotspot service provider. In one embodiment, the first device 110a reports an amount of available resources allocable for hotspot service provision to the hotspot manager 104. Alternatively or in addition, the registration engine 118 may independently place a limit on resources that can be used by a device assigned to be a hotspot service consumer. This limit may be based on a number of devices seeking hotspot access. Thus, for example, if a first subscriber pays for a high level of resources such as minutes or data volume, and only uses a fraction of the resources paid for, some of the unused resources of the first subscriber may be allocated to the provision of hotspot services to the second subscriber. In one embodiment the hotspot manager 104 may select an Internet service provider (ISP) from a plurality of vendors. Alternatively, the second device 110b acting a hotspot service consumer may select an ISP and report this selection to the hotspot manager 104 via the first device 110a acting as the hotspot service provider.

The resource usage calculator 120 monitors and/or calculates resource usage of the resources of a hotspot service provider by a hotspot service consumer. For example, an amount of resources used by the hotspot resource consumer may be reported to the hotspot manager 104. The amount of resource usage may be an amount of data transferred to or from a hotspot service consumer, or an amount of time of access to a service obtained by the hotspot service consumer. The amount of resource usage may be transmitted to the hotspot service consumer which may display the amount in currency or resources used. The amount of resource usage may be computed and stored in either of the hotspot manager or the hotspot service provider and may be displayed at either device or at both devices. For example, the first subscriber, acting as the hotspot service provider may monitor the amount of its resources being used by the second subscriber, acting as the hotspot service consumer. The monitored resources may be communicated to the hotspot service manager. The hotspot service manager may compute a price for the amount of resource used and communicate the price to the second subscriber device via the first subscriber device.

The account adjustor 122 is operable to charge an account of a hotspot service consumer and to credit an account of a hotspot service provider. Thus, the account adjustor may charge a first amount from a first account of a second subscriber, where the amount is based on resource usage of a first set of resources of a first subscriber by the second subscriber, and credit at least a portion of the amount to a second account of the first subscriber. The amount to be charged may be predetermined according to terms of an agreement between the first subscriber and the hotspot manager, the first subscriber and the Internet service provider, the first subscriber and the second subscriber, the second subscriber and the hotspot manager, or the second subscriber and the Internet service provider.

The processor 114 may further give notice to the second subscriber when an amount of accessible resources of the first subscriber is at or near exhaustion. Also, the hotspot manager may automatically switch from designating the first device as a hotspot service provider to designating the fourth device as a hotspot service provider when the resources of the first device are near exhaustion or fall below a threshold. Further, the amount of resources allocated to the second subscriber may be based on a number of devices seeking access to a service. For example, fewer resources may be allocated to any one particular subscriber when the demand for resources by other subscribers is high.

One embodiment is a first device, such as the device 110a, that is configurable to provide a hotspot service. The first device includes a memory, a processor and a wired or wireless communication module, e.g., wired or wireless communication hardware, software and antenna. The memory may be configured to store or record an amount of resources allocable to a second device. The processor may be configured to authorize the second device to receive access to a first server via the first device. The authorizing may be based on information received from one of the first server and a second server. For example, the first server may be a hotspot manager 104 and the second server may be an Internet service provider 102. The device 110a may also include components such as a display unit, input devices, and the like. It is contemplated that the memory may include non-volatile memory such as a hard drive, flash memory, etc. in addition to volatile memory.

In one embodiment, when the second device seeks access via the first device, the first device will send a logon screen to the second device. The user of the second device may logon to the first device by inputting identification information such as a user name and password. The first device may forward the identification information from the second device to the hotspot manager 104 which authenticates the second device based on the identification information. The hotspot manager may then send authorization to the first device to enable Internet access to the second device via the first device.

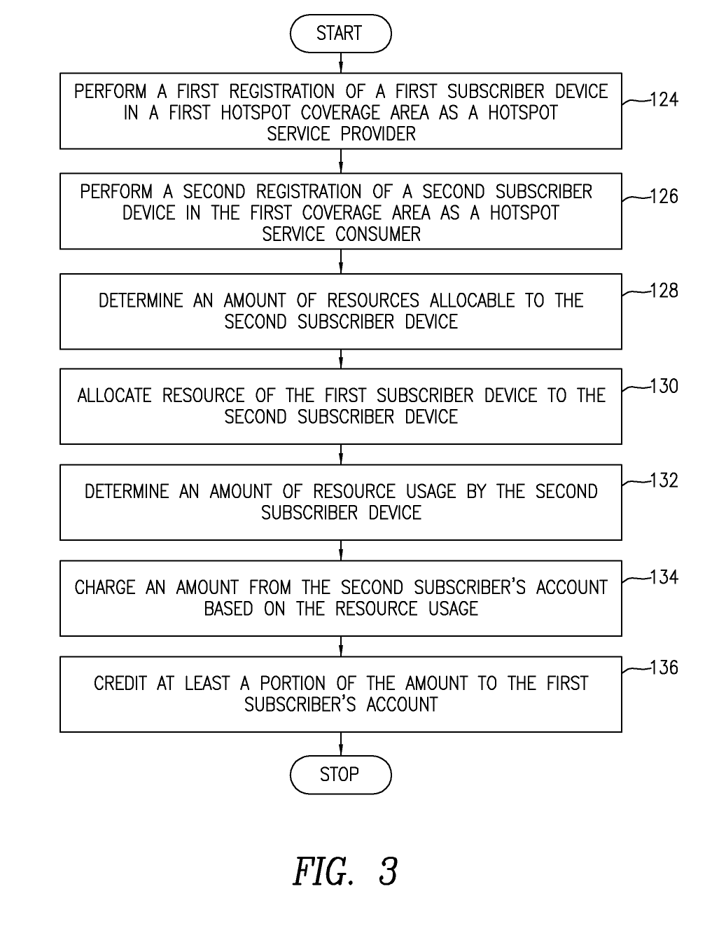

FIG. 3 is a flowchart of an exemplary process for using a subscriber device as a hotspot service provider in accordance with principles of the present invention. A first registration of a first subscriber device in a first hotspot coverage area as a hotspot service provider is performed (step 124). A second registration of a second subscriber device in the first hotspot coverage area as a hotspot service consumer is performed (step 126). An amount of resources allocable to the second subscriber device is determined (step 128). Resources of the first subscriber device are allocated to the second subscriber device (step 130). An amount of resource usage by the second subscriber device is determined (step 132). An amount is charged from the second subscriber's account based on the determined resource usage (step 134). At least a portion of the amount is credited to the first subscriber's account (step 136).

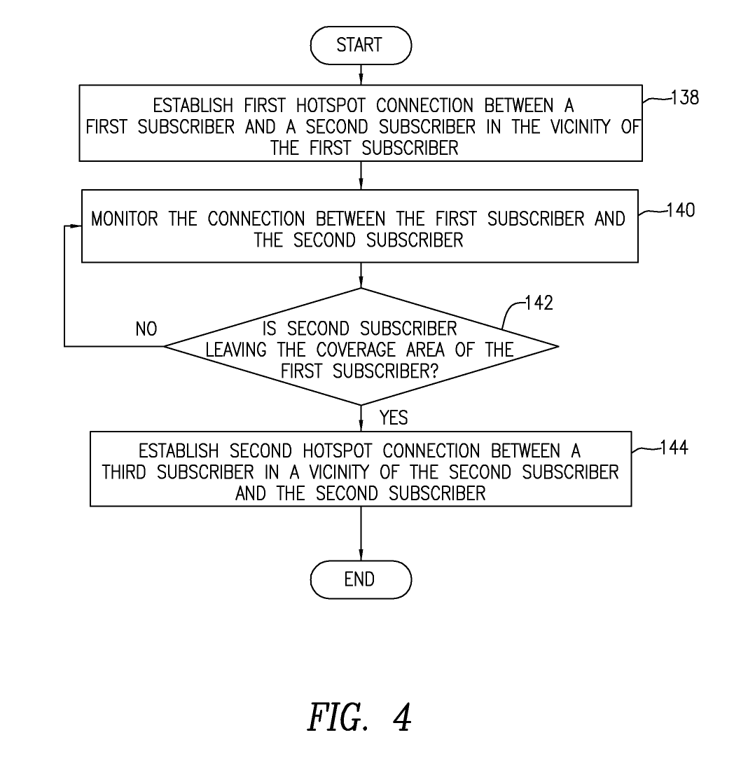

FIG. 4 is a flowchart of an exemplary process for transferring hotspot functionality from a first subscriber in first coverage area to a third subscriber in a second coverage area. A first hotspot connection is established between a first subscriber in the first coverage area and a second subscriber in the first coverage area (step 138). The connection between the first subscriber and the second subscriber is monitored (step 140). A determination is made as to whether the second subscriber is leaving the first coverage area (step 142). If not, then the monitoring of step 140 continues. If the second subscriber is leaving the first coverage area, then a second wireless hotspot connection is established between the second subscriber and a third subscriber in a second coverage area, the third subscriber functioning as a hotspot service provider for the second coverage area (step 144).

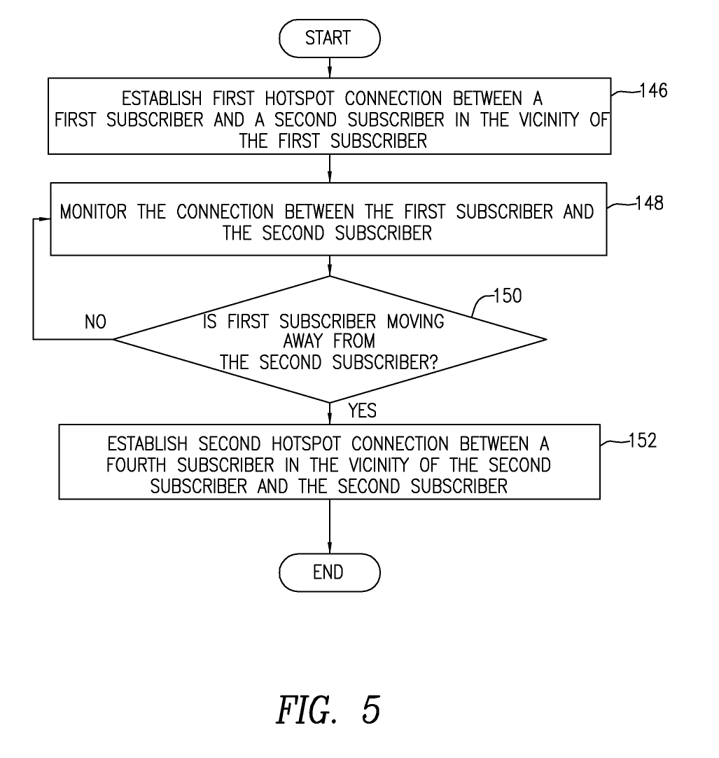

FIG. 5 is a flowchart of an exemplary process for transferring hotspot functionality from a first subscriber in a first coverage area to a fourth subscriber whose coverage area partially or substantially overlaps the first coverage area and encompasses the location of the second subscriber. A first hotspot connection is established between a first subscriber in the first coverage area and a second subscriber in the first coverage area (step 146). The connection between the first subscriber and the second subscriber is monitored (step 148). A determination is made as to whether the first subscriber is moving away from the second subscriber (step 150), so that the coverage area of the first subscriber no longer encompasses the second subscriber's location. If not, then the monitoring of step 148 continues. If the first subscriber is moving away from the second subscriber, then a second hotspot connection is established between the second subscriber and a fourth subscriber having a coverage area that encompasses the second subscriber's location, the fourth subscriber functioning as a hotspot service provider for the second subscriber (step 152).

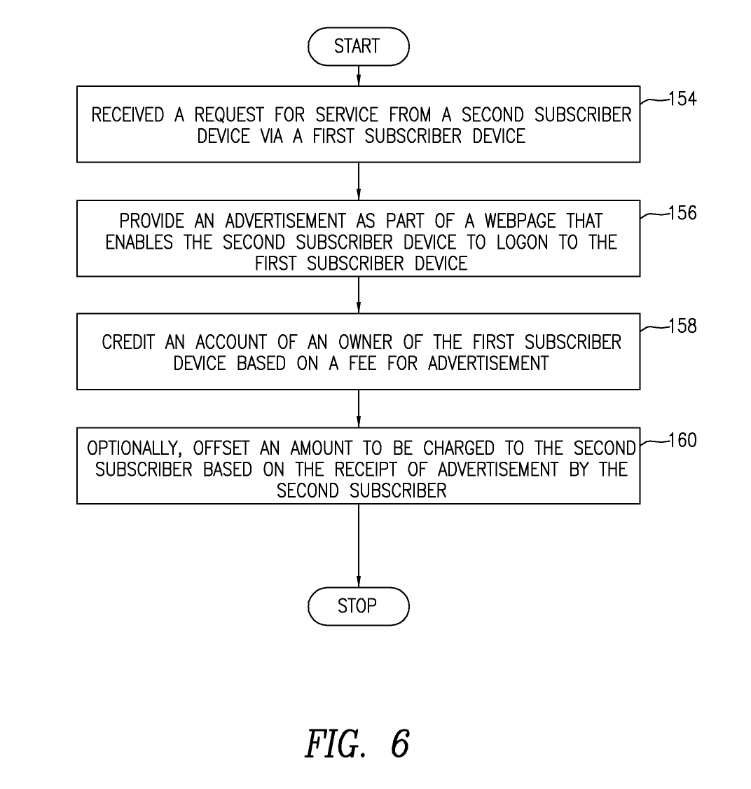

FIG. 6 is a flowchart of an exemplary process for providing advertising from a wireless hotspot manager to a subscriber. A request from a second subscriber device is received for service from a first subscriber device (step 154). An advertisement is sent to the second subscriber device via the first subscriber device. The advertisement may be part of a web page that is sent to the second subscriber device to enable the second subscriber device to logon for the service (step 156). An account of the first subscriber may be credited based on a fee paid by the sponsor of the advertisement (step 158). Optionally, an amount charged to the second subscriber may be discounted or offset by an amount based on the receipt of advertisements by the second subscriber (step 160). Thus, in one embodiment, the second subscriber may be charged a fee for advertisement-free service. In an alternative embodiment, the second subscriber may be provided advertisement-laden access without charge.

The present invention can be realized in hardware, or a combination of hardware and software. Any kind of computing system, or other apparatus adapted for carrying out the methods described herein, is suited to perform the functions described herein. A typical combination of hardware and software could be a specialized computer system, having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

1. A method for using a first mobile subscriber device as a hotspot service provider, the method comprising:
performing, by a computing device, a first registration of the first mobile subscriber device as a first hotspot service provider, the first registration including identifying an account of an owner of the first device;
performing, by a computing device, a second registration of a second mobile subscriber device in a coverage area of the first mobile subscriber device as a hotspot service consumer, the second registration including identifying an account of an owner of the second mobile subscriber device;
charging, by a computing device, a first amount against an account of the owner of the second mobile subscriber device, the first amount based on a resource usage by the second mobile subscriber device via the first mobile subscriber device; and
crediting, by a computing device, at least a portion of the first amount to the account of the owner of the first mobile subscriber device.

2. The method of claim 1, further comprising transmitting to the second mobile subscriber device via the first mobile subscriber device a webpage to enable a user of the second mobile subscriber device to log on to access a provided service.

3. The method of claim 1, wherein the first amount based on the resource usage is a flat fee associated with access to a provided service via the first mobile subscriber device.

4. The method of claim 1, wherein the first amount based on the resource usage is a fee based on an amount of data transferred to the second mobile subscriber device via the first mobile subscriber device.

5. The method of claim 1, wherein charging a first amount includes deducting the first amount from the account of the owner of the second mobile subscriber device.

6. The method of claim 1, wherein the first amount based on the resource usage is a fee based on an amount of time of access to a provided service by the second mobile subscriber device via the first mobile subscriber device.

7. The method of claim 1, further comprising:
performing a third registration of a third mobile subscriber device as a second hotspot service provider, the third registration identifying an account of an owner of the third mobile subscriber device; and
when the second mobile subscriber device exits the coverage area of the first mobile subscriber device and enters a coverage area of the third mobile subscriber device, then:
ceasing crediting the account of the owner of the first mobile subscriber device; and
commencing crediting a second amount to the account of the owner of the third mobile subscriber device, the second amount based on a resource usage by the second mobile subscriber device via the third mobile subscriber device.

8. The method of claim 7, further comprising:
signaling the third mobile subscriber device to act as a wireless hotspot service provider to the second mobile subscriber device.

9. The method of claim 1, wherein the first registration of the first mobile subscriber device includes identifying an amount of resources to be provided to a hotspot service consumer by the first mobile subscriber device.

10. A hotspot management computing device, comprising:
a memory, the memory configured to store first account information of a first mobile subscriber and second account information of a second mobile subscriber, the first mobile subscriber associated with a first mobile subscriber device arranged to function as a hotspot service provider, and the second mobile subscriber associated with a second mobile subscriber device arranged to function as a hotspot service consumer; and
a processor, the processor configured to:
perform registration of the first mobile subscriber and the second mobile subscriber;
charge a first amount from the second account of the second mobile subscriber, the amount based on resource usage of a first set of resources by the second mobile subscriber; and
credit at least a portion of the first amount to the first account of the first mobile subscriber.

11. The hotspot management computing device of claim 10, wherein the processor is further configured to monitor usage of the first set of resources and to calculate the first amount.

12. The hotspot management computing device of claim 10, wherein the processor is further configured to select the first mobile subscriber device from a plurality of mobile subscriber devices having coverage areas that encompass the second mobile subscriber device.

13. The hotspot management computing device of claim 10, wherein, when the second subscriber moves from a first cell to a second cell, the processor:
ceases crediting the first account of the first mobile subscriber; and
commences crediting at least a portion of the first amount to a third account of a third mobile subscriber having a third mobile subscriber device arranged to function as a hotspot service provider in the first cell.

14. The hotspot management computing device of claim 10, wherein the processor is further configured to determine an amount of data transferred to the second mobile subscriber device via the first mobile subscriber device.

15. The hotspot management computing device of claim 10, wherein the processor is further configured to determine an amount of resources to be accessible by the second mobile subscriber device via the first mobile subscriber device.

16. The hotspot management computing device of claim 15, wherein the processor is further configured to provide notice to the first mobile subscriber when the amount of accessible resources of the first mobile subscriber device is exhausted by the second mobile subscriber device.

17. The hotspot management computing device of claim 10, wherein the processor is further configured to determine an amount of resources of the first mobile subscriber device allocable to other devices based on a number of mobile subscriber devices seeking access to a service.

18. The hotspot management computing device of claim 10, wherein the processor is further configured to deliver an advertisement to the second mobile subscriber device via the first mobile subscriber device.

19. The hotspot management computing device of claim 18, wherein the processor is further configured to credit an amount to the first account of the first mobile subscriber based on a fee collected from a sponsor of the advertisement.

20. The hotspot management computing device of claim 10, wherein the processor is further configured to offset the first amount based on a fee for delivery of an advertisement to the second mobile subscriber device.

21. The hotspot management computing device of claim 10, wherein the processor is further configured to facilitate at least one of file sharing and text messaging between the first mobile subscriber device and the second mobile subscriber device.

22. A first mobile subscriber device configurable to provide a hotspot service, the first mobile subscriber device comprising:
a memory, the memory configured to record an amount of resources allocable to a second mobile subscriber device; and
a processor, the processor configured to:
authorize the second mobile subscriber device to receive access to a provided service via the first mobile subscriber device, the authorizing based on information received from a management computing device; and
credit the first mobile device with charges incurred by the second mobile device for resource usage via the first mobile device.

23. The first mobile subscriber device of claim 22, wherein the memory records an amount of resources allocable to the second mobile subscriber device, the first mobile subscriber device further comprising a display, the display arranged to indicate the amount of resources allocable to the second mobile subscriber device.

24. The first mobile subscriber device of claim 22, wherein the processor is further configured to determine an amount of resources of the first mobile subscriber device being used by the second mobile subscriber device, the first mobile subscriber device further comprising a display, the display arranged to indicate the amount of resources of the first mobile subscriber device being used by the second mobile subscriber device.

25. The first mobile subscriber device of claim 24, wherein the amount of resources is expressed as one of a number of bits per second and a data volume.
